(19) United States
(12) Patent Application Publication
(10) Pub. No.: US 2006/0229971 A1
(43) Pub. Date: Oct. 12, 2006

(54) ELECTRONIC TRADING SYSTEM

(75) Inventor: Brian Vincent Kelly, London (GB)

Correspondence Address: TAYLOR RUSSELL & RUSSELL, P.C., 4807 SPICEWOOD SPRINGS ROAD, BUILDING TWO SUITE 250, AUSTIN, TX, 78759, US

(73) Assignee: PATSYSTEMS (UK) LTD., London (GB)

(21) Appl. No.: 11/307,933

(22) Filed: Feb. 28, 2006

(30) Foreign Application Priority Data
Feb. 28, 2005 (GB) 0504074.6

(51) Int. Cl. G06Q 40/00

(52) U.S. Cl. 705/37

(57) ABSTRACT

A client terminal for use in an electronic trading system is disclosed. The client terminal comprises a data interface for sending data to and receiving data from a server; and a user interface including a display for presenting information to a user and receiving trading commands from a user. In the terminal, the user interface displays a rectangular grid containing rows and columns of values, each row (or column) referring to a specific future expiry date and each column (or row) referring to a commodity and/or strategy been traded, the particular expiry dates and commodities and/or strategies being selectable by a user. This grid-like layout allows a large amount of information to be displayed in a comparatively small area of a display, with little of the area occupied not containing useful information. Multiple commodities and strategies can be displayed simultaneously.

This application claims priority of United Kingdom Patent Application Number 0504074.6, filed on Feb. 28, 2005.

### BACKGROUND TO THE INVENTION

1. Field of the Invention

This invention relates to an electronic trading system. In particular, it relates to a system for trading commodities, for example, futures, options, shares, currencies, stocks, bonds and so forth.

An increasing number of markets have been converted from a manual system of trading, in which traders operate from a market trading floor, to an electronic system of trading in which traders operate from remotely connected computers. Such electronic markets operate trading host computers, which actually perform the trading function. The traders interact with the hosts by means of client computers, connected to the host by a local area and/or wide area network link. The host computer executes software that allows a trader to be appraised of the status of the market and to perform trading activities.

Clearly, it is of particular importance that information relating to the market is provided to the trader in a clear and timely manner. This is essential as it allows the trader to buy and sell commodities at a desired price. In many cases, there is a very large amount of information to be presented to a trader. Presenting this information in a manner that can be comprehended quickly and accurately presents a considerable technical challenge.

2. Summary of the Prior Art

One particular class of commodities that are traded using electronic systems is futures. These can be broken into a number of market segments. One such market segment trades yield curve futures products (also known as STIRs). Yield curve futures products generally have a number of consecutive delivery dates, which attempt to reflect the market's perception of an interest-rate-based product (e.g. Euribor, Eurodollar, Bond contracts) for a set period of time.

Traders, at the moment, try to make sense of this information using screens that show an individual contract (e.g. Euribor) with its expiry dates (each one will be called an instrument to simplify the explanation: e.g. Euribor\Mar05 or Euribor\Jun05), and the spreads between each expiry date (e.g. Mar05Jun05, Mar05Sep05); the instruments are displayed at the top and bottom of each column, the spread(s) displayed between the instruments.

Such screens have several disadvantages. Firstly, there is a lot of wasted screen space. Secondly, the screen is limited to calendar spreads; other products which are made up from these instruments include flies, condors, packs and bundles. Moreover, it cannot display different contracts either from one exchange or across several exchanges. For example, one cannot view both the CME\Eurodollar and the LIFFE\Eurodollar at the same time.

### SUMMARY OF THE INVENTION

An aim of this invention is to provide a trading screen, particularly for futures, that overcomes or at least ameliorates the above disadvantages.

From first aspect, this invention provides a client terminal for use in an electronic trading system comprising:

a data interface for sending data to and receiving data from a server; and

a user interface including a display for presenting information to a user and receiving trading commands from a user;

in which the user interface displays a rectangular grid containing rows and columns of values, each row (or column) referring to a specific future expiry date and each column (or row) referring to a commodity been traded, the particular expiry dates and commodities being selectable by a user.

The invention also provides a method of displaying information on a user interface screen of a trading client terminal, the method comprising:

receiving data from data interface from a trading server; and

displaying upon the screen a rectangular grid containing rows and columns of values, each row (or column) referring to a specific future expiry date and each column (or row) referring to a commodity been traded, the particular expiry dates and commodities being selectable by a user.

This grid-like layout allows a large amount of information to be displayed in a comparatively small area of a display, with little of the area occupied not containing useful information. Multiple commodities and strategies can be displayed simultaneously.

In a typical mode of operation, when a user selects a cell in the grid, for example by moving a mouse pointer over it, cells that contain data relating to individual legs of a trade that the cell identifies are highlighted. Column (or row) names (advantageously, with expiry dates) may also be highlighted. For example, if the cell represents a calendar spread, the cells that represent the buy leg and the sell leg will be highlighted along with the relevant column headings for each expiry.

Preferably, the user can select arbitrary expiry dates. That is to say, it is preferable that the user is not compelled to select dates simply according to a predetermined pattern (e.g., every month or every quarter).

Typically, the topmost row and the leftmost column contain cells that include descriptive information to describe the corresponding column and row. The information contained in any cell can therefore be determined by combining their descriptive information of the column and row that intersect at the particular cell.

It may be, that the user can select from several pre-defined strategies and/or commodities to be included in the display. Alternatively, the user may specify custom strategies and/or commodities to be included. The strategies may include one are more of: a fly, a condor, a pack, a bundle or a strip. The period of the strategy may also be selected by the user.

From another aspect, this invention provides an electronic trading system comprising a server and a plurality of client terminals according to any preceding claim interconnected in a data network.

From a further aspect, this invention provides a computer software product executable on computer hardware to constitute a client terminal according to the first aspect of the invention.

### BRIEF DESCRIPTION OF THE DRAWINGS

FIG. 1 shows a display upon a trading terminal being an embodiment of the invention;

FIG. 2 shows a dialog box and that can be displayed by the terminal of FIG. 1 to enable a user to select expiry dates;

FIG. 3 shows a dialog box that can be displayed by the terminal of FIG. 1 to enable the user to select trading strategies and time gaps;

FIG. 4 shows an alternative dialog box with which a user can select expiry dates;

FIG. 5 shows an display of contracts that can be selected by a user for display; and

FIG. 6 shows a network of computers operating as an electronic trading system.

### DETAILED DESCRIPTION OF THE PREFERRED EMBODIMENT

An embodiment of the invention will now be described in detail, by way of example, and with reference to the accompanying drawings.

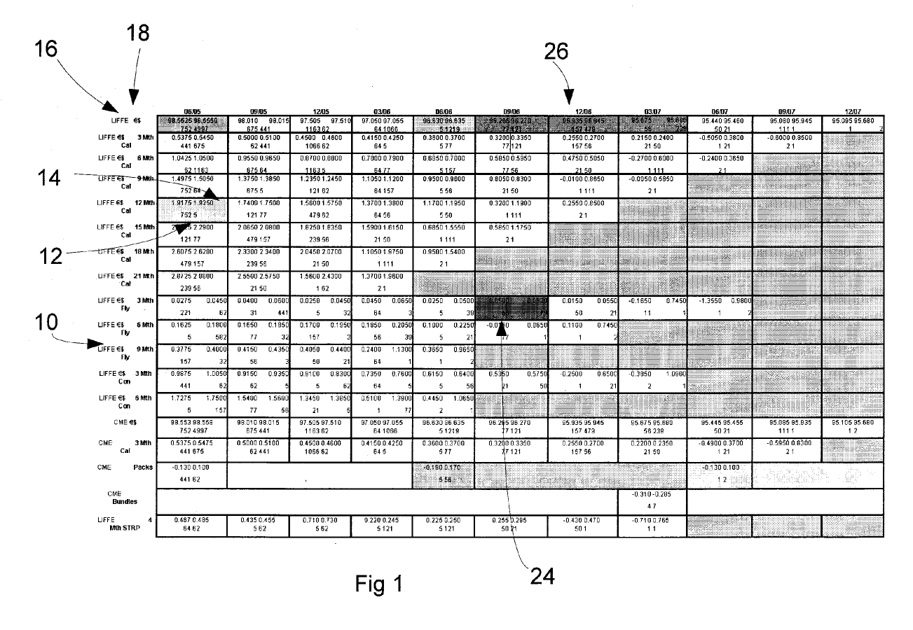

With reference to FIG. 1, a display on a trading terminal includes a grid 10, comprising several rows and several columns of cells. Within each cell, there can be displayed bid price and volume and offer price and volume, these been shown, respectively, at 12 and 14. Optionally, a user can choose to have displayed the last traded price and volume and implied prices, where appropriate. If prices in the underlying contracts exist for any of the following strategies: calendar spreads, flies, condors, packs and bundles, but the price of the strategy is not being received from the exchange, then the system will indicatively price the strategy within the appropriate grid cell when implied prices are on. Strategies being indicatively priced locally (as opposed to exchange implied) will have a different border color.

The topmost row 16 and the leftmost column 18 comprise cells that display headings for, respectively, are the columns and rows. The row headings indicate the particular commodity or commodity strategy that is represented within the row. Typically, these are textual descriptions of the commodity concerned. Dependent upon the strategy in question, the column headings either indicate the first or last expiry date for a strategy that is represented in the column below. The cells in the topmost row 16 also include bid price and volume and offer price and volume. A row can consist of either an individual contract or a strategy (calendar spread, butterfly spread, condor spread, pack, bundle or strip, etc.).

Users define the contract expiry dates to view (e.g. Jun-04, Sep-04, Dec-04) as columns in the grid. The user can set up each row by defining the time between expiry dates or strategies.

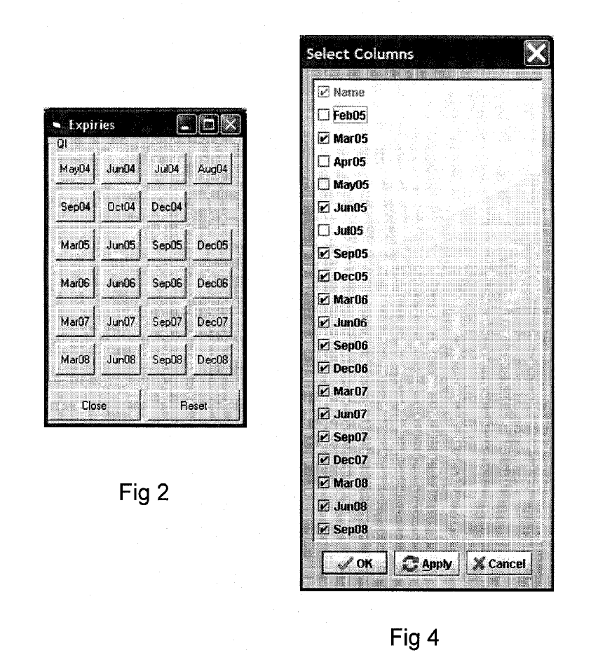

It is up to the user to choose the expiry dates that will be represented in the various columns. In this embodiment, this is done using a dialog box as shown in FIG. 2. It will be seen from FIG. 2 that the columns displayed in FIG. 1 are those that have been highlighted in the dialog of FIG. 2. A user can toggle an expiry date on or off simply by pointing at it with a pointing device (typically, a mouse) and performing an action such as a mouse click, or selection from a list, amongst other possibilities.

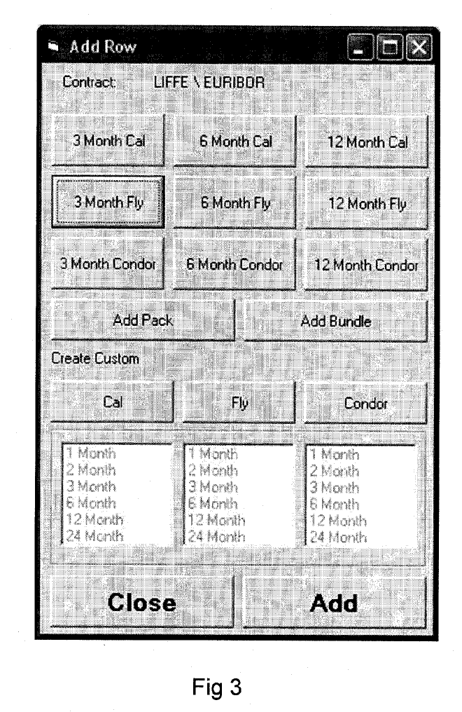

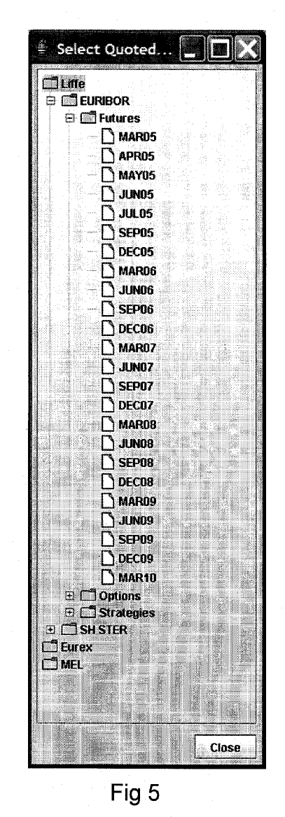

Likewise, the user can choose the commodities and strategies that will be represented in the various rows a dialog box illustrated in FIG. 3. As with the dates, the user can toggle several pre-defined strategies simply by clicking on the appropriate button. An alternative dialog, with similar functionality, is shown in FIG. 4. Additionally, the user is given the option of selecting the time between each expiry within the row. This effectively overrides the settings made in the dialog of FIG. 2. Alternatively a contract can be dragged directly onto the screen from the contract ladder. This is a dialog, as shown in FIG. 5, that lists all contracts available for trade in a hierarchical manner. Once on the screen, rows and columns can be re-ordered by dragging using a pointer or by other mechanisms.

For example, the cell 20 is displaying the bid price and volume, and the offer price and volume, for the calendar spread Jun-05/Jun-06, this data having been received from the exchange. To assess the likely benefit of the calendar spread, the trader needs to be presented with data relating to both legs of the spread—the earlier-expiring buy and the later expiring sell—as well as the data for the specific strategy. The expiries are shown at 22, highlighted on the display in a color such as orange, and the row heading, at 30, is also highlighted. Thus, when the user points at the cell 20 relating to the calendar spread Jun-04/Jun-05, the cells that show trading data relating to the Jun-05 and Jun-06 are highlighted.

Other strategies require different combinations of data to be presented. The cell at 24 is displaying the bid price and volume, and the offer price and volume, for the fly spread Jun-04/Jun-05. This strategy involves a combination of buys and sells with three different expiry dates. The expiries are shown at 26 highlighted in an alternative color, such as blue. Cells representing packs align with the first contract month in strategy, and those representing bundles align with the last contract month strategy.

The cells are highlighted when the mouse pointer is moved over a cell that identifies a particular trading strategy. This is to ensure that a user has a visual confirmation of the expiries involved in a strategy before committing to trade.

The cells along the top row identify contracts with a specific expiry date. These can be used to enable a trader to trade outright, rather than trading using a strategy.

Thus, an embodiment of the invention can displays packs, bundles, calendars, flies, condors and outright positions, display prices from different contracts and exchanges, and display the key information required to trade yield curve strategies, and allow a trader to trade outright.

To initiate a trade, the user performs a specific action in relation to the cell that identifies the specific trading strategy. Typically, the action will be a mouse click with a specific mouse button, on a specific part of the cell. Depending upon the specifics of the embodiment, this action may be configurable by the user, but since this is already known in the technical field, it will not be described here further.

In an alternative embodiment, the functions of the rows and columns are reversed. That is, the expiry dates defined in the leftmost column, and the commodity and strategy in the topmost row. In some embodiments, the user may be given the choice of which orientation to use. In a special case, where the user adds only one contract and also specify rows as expiries, the system embodying the invention can be made to mimic a calendar spread matrix of the type presently in use. This allows the additional functionality of the new display to be introduced by individual users as and when it is thought to be advantageous.

It will be understood that the display component described above will be just one of many display components that can be displayed by a client terminal. As such, it will typically be integrated into a larger suite of trading software.

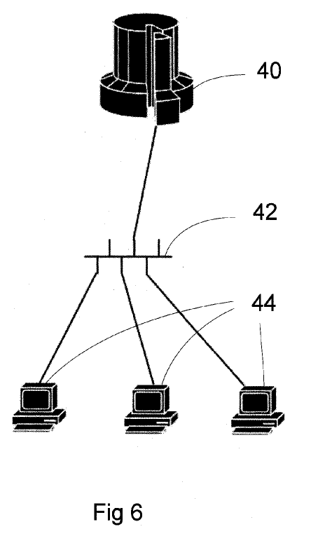

With reference first to FIG. 6, a typical electronic market, within which embodiments of the invention will typically operate, can be represented as several computers connected in a network in a client/server arrangement.

The organization running the market provides a server computer 40—an electronic exchange. This is connected over a network 42 to multiple client computers 44. The network can include many diverse components, some local-area and some wide-area, as required by the geographical distribution of the clients, and may, for example, include local-area Ethernet, long-distance leased lines and the Internet

In a typical case, the server is a high-powered computer or cluster of computers capable of handling substantially simultaneous requests from many clients. Each client is typically a considerably smaller computer, such as a single-user workstation, that is connected to a local-area portion of the network. For the purposes of this illustrative embodiment, each client is a personal computer having a Java virtual machine running under the Microsoft Windows XP operating system. In this embodiment, the software program is a Java program that executes within the virtual machine.

When a client 44 connects to the server 40, it is delivered over the network 42 a stream of data that represents the instantaneous state of the market. This data includes a description of all outstanding bids and asks, and of any trading activity within the market. The client 44 can also send a request over the network 42 to the server 40 to initiate a trading action. Typically, each client may be able to connect to several hosts to enable it to trade in several markets.

The above description is a simplification of an actual implementation of an electronic trading system. However, the components described are entirely familiar to those skilled in the technical field, as will the details of how they might be implemented in practice, so they will not be described here further.

Each client 44 executes a software program that allows a user to interact with the server 40 by creating a display that represents data received from the server 40 and sending requests to the server 40 in response to a user's input. Thus, the client, the software it executes, and the method by which it operates constitute an embodiment of the invention.

EURIBOR is a registered trademark of EURIBOR Fédération Bancaire Européenne.

MICROSOFT and WINDOWS are trademarks of Microsoft Corporation

What is claimed is:

1. A client terminal for use in an electronic trading system comprising:
a data interface for sending data to and receiving data from a server; and
a user interface including a display for presenting information to a user and receiving trading commands from a user;
in which the user interface displays a rectangular grid containing rows and columns of values, each row (or column) referring to a specific future expiry date and each column (or row) referring to a commodity and/or strategy been traded, the particular expiry dates and commodities and/or strategies being selectable by a user.

2. A client terminal according to claim 1 in which, when a user selects a cell in the grid, for example by moving a mouse pointer over it, cells that contain data relating to individual legs of a trade that the cell identifies.

3. A client terminal according to claim 1 in which where the cell represents a calendar spread, the cells that represent the buy leg and the sell leg will be highlighted along with the relevant column headings for each expiry.

4. A client terminal according to claim 2 in which, when a user selects a cell in the grid, associated column (or row) headings are highlighted.

5. A client terminal according to claim 1 in which the user can select arbitrary expiry dates.

6. A client terminal according to claim 1 in which the topmost row and the leftmost column contain cells that include descriptive information to describe the corresponding column and row.

7. A client terminal according to claim 1 in which the user can select from several pre-defined strategies and/or commodities to be included in the display.

8. A client terminal according to claim 1 in which the user can specify custom strategies and/or commodities to be included.

9. A client terminal according to claim 1 in which the user can select from strategies including one are more of: a fly, a condor, a pack, a bundle or a strip.

10. A client terminal according to claim 1 in which the user can select the period of the strategy.

11. An electronic trading system comprising a server and a plurality of client terminals according to claim 1 interconnected in a data network.

12. A computer software product executable on computer hardware to constitute a client terminal according to claims 1.

13. A method of displaying information on a user interface screen of a trading client terminal, the method comprising:
receiving data from data interface from a trading server; and
displaying upon the screen a rectangular grid containing rows and columns of values, each row (or column) referring to a specific future expiry date and each column (or row) referring to a commodity been traded, the particular expiry dates and commodities being selectable by a user.
